(19) United States
(12) Patent Application Publication
(10) Pub. No.: US 2005/0051369 A1
(43) Pub. Date: Mar. 10, 2005

(54) Electrical wheelchair with an electrical height adjustable seat

(75) Inventors: Shean-Juinn Chiou, Taichung City (TW); Jau-Liang Chen, Taichung City (TW); Jong-Fang Ho, Taichung City (TW)

Correspondence Address: OSTROLENK FABER GERB & SOFFEN, 1180 AVENUE OF THE AMERICAS, NEW YORK, NY, 100368403, US

(73) Assignees: National Chung-Hsing University; Chung Shan Medical University

(21) Appl. No.: 10/876,923

(22) Filed: Jun. 25, 2004

(30) Foreign Application Priority Data
Sep. 10, 2003 (TW) 092216327

(51) Int. Cl. B60K 1/00

(52) U.S. Cl. 180/65.1

(57) ABSTRACT

An electrical wheelchair includes a driving motor with a horizontal motor shaft, and a seat-moving unit that includes a vertical threaded rod journalled on a frame, and a driven tube having an upper end that is connected fixedly to a seat member. A speed reduction unit transfers rotation of the motor shaft to the threaded rod. The threaded rod engages threadably a lower end of the driven tube such that rotation of the threaded rod can be converted into vertical movement of the driven tube and the seat member. As such, the driving motor can be actuated to adjust the height of the seat member.

### CROSS-REFERENCE TO RELATED APPLICATION

This application claims priority of Taiwanese Application No. 092216327, filed on Sep. 10, 2003.

### BACKGROUND OF THE INVENTION

1. Field of the Invention

This invention relates to an electrical wheelchair, and more particularly to an electrical wheelchair with a seat height-adjusting device.

2. Description of the Related Art

A manually operated seat height-adjusting device has been used on a wheelchair. However, it is difficult for a disabled user to perform manual seat height-adjusting operation.

### SUMMARY OF THE INVENTION

The object of this invention is to provide an electrical wheelchair that includes an electrical seat height-adjusting device which can be operated with ease.

According to this invention, an electrical wheelchair includes a driving motor with a horizontal motor shaft, and a seat-moving unit that includes a vertical threaded rod journalled on a frame, and a driven tube having an upper end that is connected fixedly to a seat member. A speed reduction unit transfers rotation of the motor shaft to the threaded rod. The threaded rod engages threadably a lower end of the driven tube such that rotation of the threaded rod can be converted into vertical movement of the driven tube and the seat member. As such, the driving motor can be actuated to adjust the height of the seat member.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly exploded perspective view of the preferred embodiment of an electrical wheelchair according to this invention;

FIG. 1A is a schematic front view of a speed reduction unit of the preferred embodiment;

FIG. 2 is an assembled perspective view of the preferred embodiment;

FIG. 3 is a fragmentary perspective view of a driving motor, the speed reduction unit, and a seat-moving unit of the preferred embodiment;

FIG. 4 is a sectional view of the seat-moving unit of the preferred embodiment;

FIG. 5 is a schematic fragmentary side view of the seat-moving unit of the preferred embodiment, illustrating engagement between a threaded rod and a driven tube; and

FIG. 6 is a schematic side view of the preferred embodiment, illustrating how a seat member is moved upwardly.

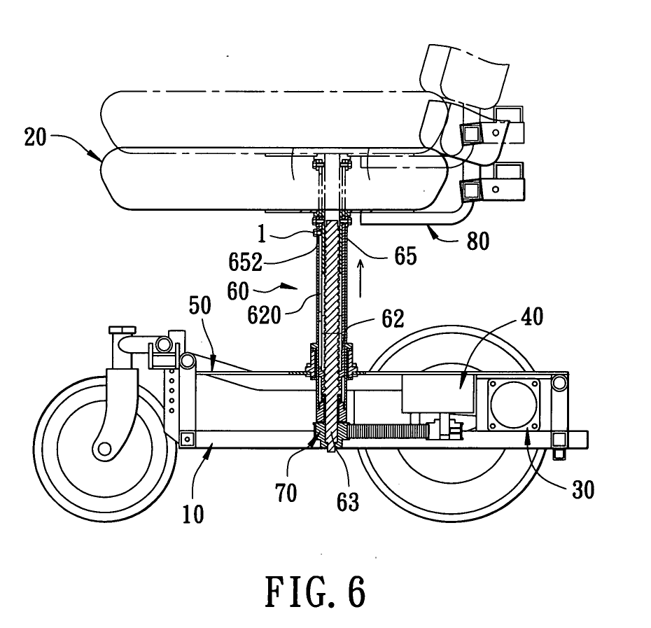

### DETAILED DESCRIPTION OF THE PREFERRED EMBODIMENT

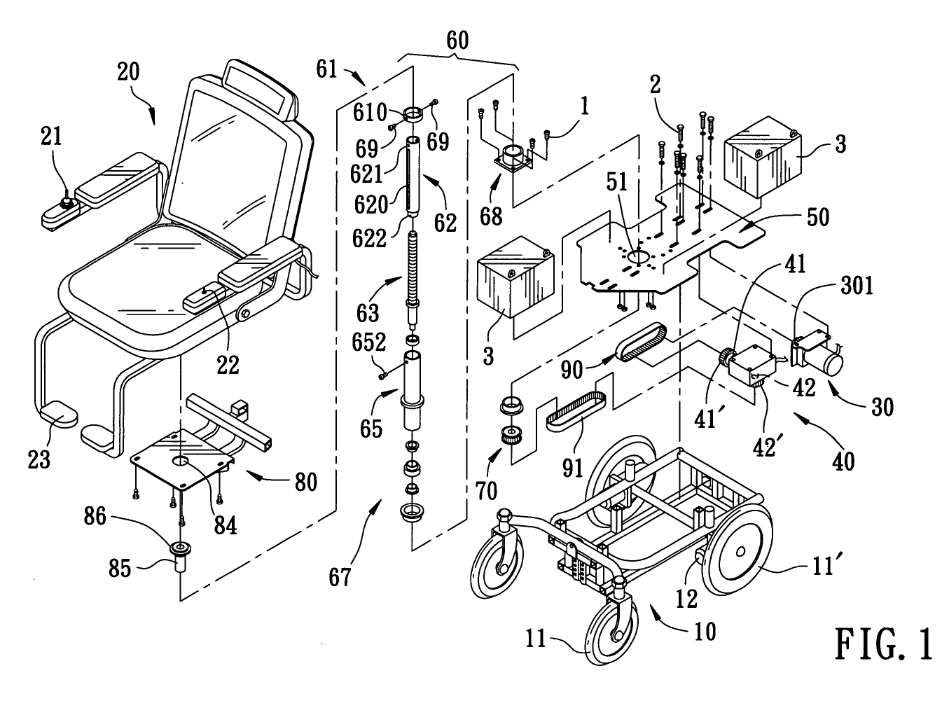

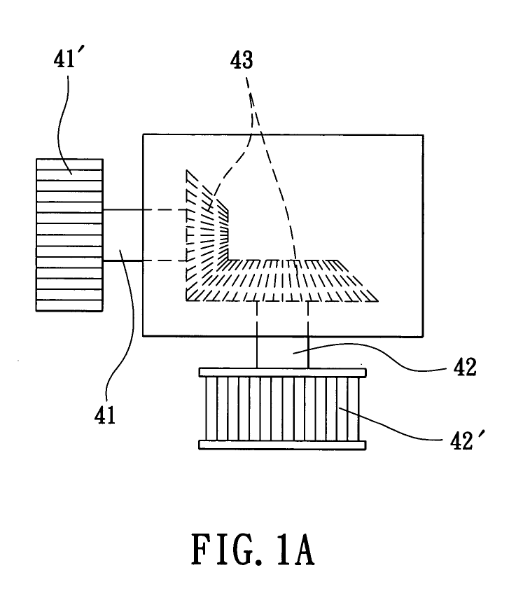

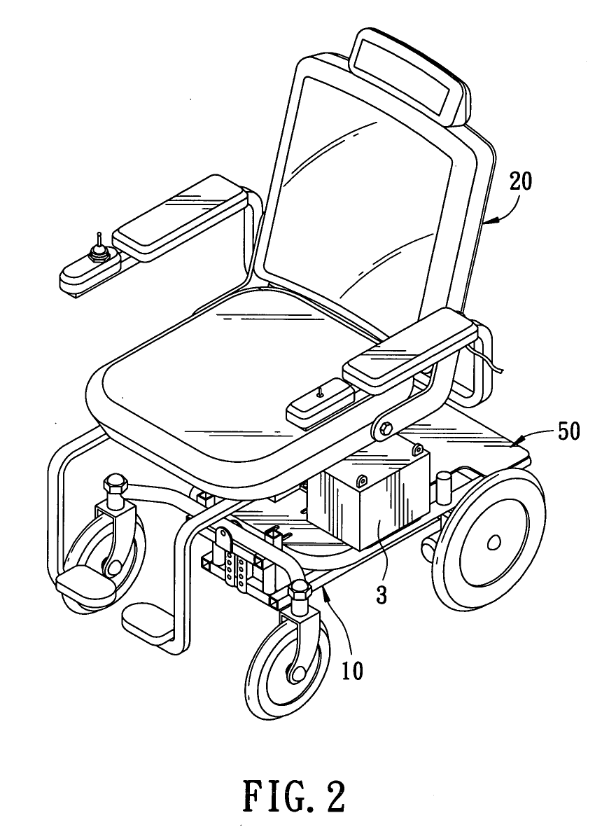

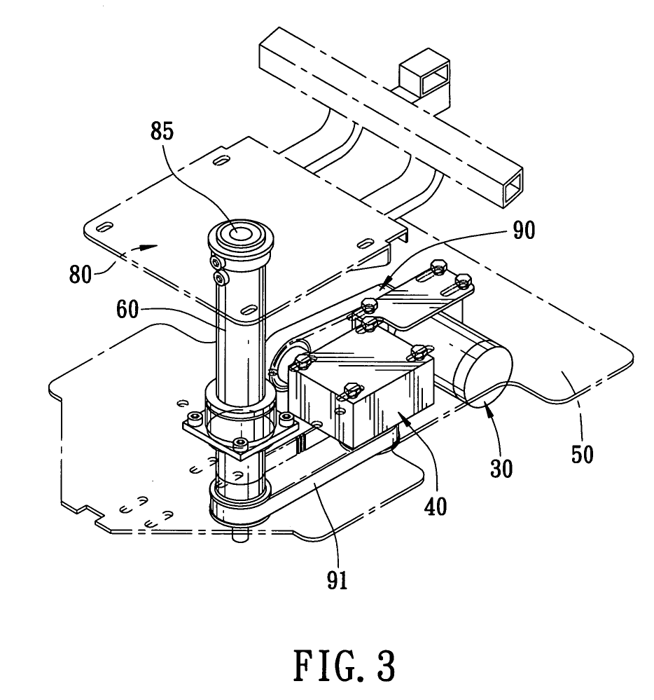

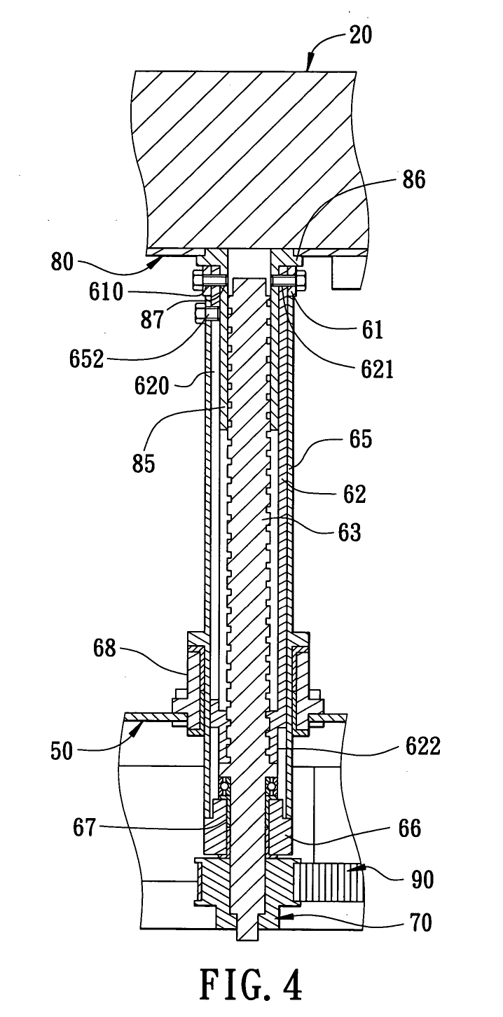

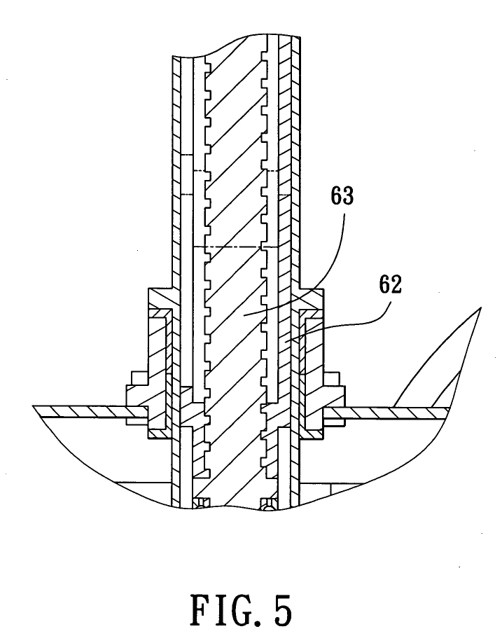

Referring to FIGS. 1, 1A, 2, 3, 4, and 5, the preferred embodiment of an electrical wheelchair according to this invention is shown to include a chair body 10, a seat member 20, a driving motor 30, a speed reduction unit 40, a horizontal mounting plate 50, a seat-moving unit 60, a driven gear 70, a seat-supporting plate 80, two driving belts 90, 91, a plurality of first bolts 1, a plurality of second bolts 2, and two battery cases 3.

The chair body 10 includes two front wheels 11, a driving wheel unit consisting of two rear driving wheels 11′, and a frame 13, on which the front wheels 11 and the rear driving wheels 11′ are disposed rotatably.

The seat member 20 is disposed above the frame 13, and includes a wheel-controlling switch 21 disposed on a right armrest of the seat member 20, a seat-controlling switch 22 disposed on a left armrest of the seat member 20, and a fixed footrest 23. The wheel-controlling switch 21 is operable to rotate the rear driving wheels 11′ on the frame 13.

The driving motor 30 is provided with a motor shaft 301 that is formed with a gear 31 sleeved fixedly thereon.

The speed reduction unit 40 includes a horizontal input rod 41 (see FIG. 1A) and a vertical output rod 42 (see FIG. 1A) that are journalled on the frame 13. Each of the input rod 41 and the output rod 42 is formed with a gear 41′, 42′ sleeved fixedly thereon. The driving belt 90 has a toothed inner surface, and is trained on the gears 31, 41′ of the motor shaft 301 and the input rod 41 so that rotation of the motor shaft 301 can be transferred to the input rod 41. The output rod 42′ is connected to the input rod 41′ by two bevel gears 43 that mesh with each other so that rotation of the input rod 41 can be transferred to the output rod 42. The rotational speed of the output gear 42 is smaller than that of the input rod 41.

The horizontal mounting plate 50 is connected threadedly to the frame 13 by the second bolts 2, and is formed with a circular hole 51. The battery cases 3 are fixed on the horizontal mounting plate 50.

The seat-moving unit 60 includes a connecting ring 61, a vertical driven tube 62, a vertical threaded rod 63, a vertical guiding member 65, a positioning ring 66, a bearing assembly 67, and a bearing seat 68. The bearing seat 68 is connected fixedly to the horizontal mounting plate 50 by the first bolts 1, and extends through the circular hole 51 in the mounting plate 50. The guiding member 65 is configured as a vertical tube, and is press fitted within the bearing seat 68. The positioning ring 66 is disposed within and is welded to a lower end of the guiding member 65. Two positioning pins 69 extend through holes 610 in the connecting ring 61 and holes 621 in the driven tube 62 so as to fix the driven tube 62 relative to the connecting ring 61 and the seat member 20. The threaded rod 63 is journalled within the guiding member 65 by the bearing assembly 67. The driven gear 70 is sleeved fixedly on a lower end of the threaded rod 63. The driving belt 91 has a toothed inner surface, and is trained on the gears 42′, 70 so as to transfer rotation of the output rod 42 of the speed reduction unit 40 to the threaded rod 63. The driven tube 62 has an internally threaded lower end 622 that engages threadably the threaded rod 63 so that rotation of the threaded rod 63 relative to the chair body 10 can be converted into vertical movement of the driven tube 62 relative to the chair body 10.

The driven tube 62 has an outer surface that is formed with a vertical slide slot 620. The guiding member 65 has an inner surface that is provided with a fixed guiding bolt 652 which is received slidably within the slide slot 620 in the driven tube 62 so as to permit vertical movement of the driven tube 62 within the guiding member 65 and so as to prevent rotation of the driven tube 62 within the guiding member 65.

The seat-supporting plate 80 is connected threadedly to the seat member 20, and has a circular central hole 84 formed therethrough. A connecting tube 85 has an upper end extending through the central hole 84 in the seat-supporting plate 80 and welded to the seat-supporting plate 80, a lower end extending into the driven tube 62, an outward flange 86 extending radially and outwardly from an intermediate portion of the connecting tube 85 and abutting against a bottom surface of the seat-supporting plate 80, and two holes 87. The positioning pins 69 extend through the holes 87 in the connecting tube 85. As such, the seat member 20 is fixed relative to the driven tube 62.

Rotation of the motor shaft 301 can be controlled with ease by actuation of the seat-controlling switch 22. Thus, the object of this invention can be achieved.

With this invention thus explained, it is apparent that numerous modifications and variations can be made without departing from the scope and spirit of this invention. It is therefore intended that this invention be limited only as indicated by the appended claims.

1. An electrical wheelchair comprising:
a chair body including a frame and a driving wheel unit disposed rotatably on said frame;
a seat member disposed above said frame and including a wheel-controlling switch and a seat-controlling switch that are disposed on said seat member, said wheel-controlling switch being operable to rotate said driving wheel unit on said frame;
a driving motor with a horizontal motor shaft;
a speed reduction unit including a horizontal input rod and a vertical output rod that are journalled on said frame, said input rod being connected to said motor shaft such that rotation of said motor shaft is transferred to said input rod, said output rod being connected to said input rod such that rotation of said input rod is transferred to said output rod, rotational speed of said output rod being smaller than that of said input rod;
a seat-moving unit including a vertical threaded rod journalled on said frame and connected to said output rod of said speed reduction unit such that rotation of said output rod is transferred to said threaded rod, a vertical driven tube having an upper end connected fixedly to said seat member and an internally threaded lower end that engages threadably said threaded rod, and a guiding member for guiding said driven tube to move vertically relative to said frame and for preventing rotation of said driven tube relative to said frame so that rotation of said threaded rod relative to said chair body can be converted into vertical movement of said driven tube and said seat member relative to said chair body.

2. The electrical wheelchair as claimed in claim 1, wherein said guiding member of said seat-moving unit is constructed as a vertical tube that is fixed on said frame and that is sleeved around said driven tube of said seat-moving unit, one of said guiding member and said driven tube being formed with a vertical slide slot, the other one of said guiding member and said driven tube being provided with a fixed guiding bolt that is received slidably within said slide slot so as to guide said driven tube to move vertically within said guiding member and so as to prevent rotation of said driven tube within said guiding member.

3. The electrical wheelchair as claimed in claim 1, wherein each of said motor shaft of said driving motor and said input rod of said speed reduction unit is formed with a gear sleeved fixedly thereon, said wheelchair further comprising a driving belt that has a toothed inner surface and that is trained on said gears of said motor shaft and said input rod so as to transfer the rotation of said motor shaft to said input rod.

4. The electrical wheelchair as claimed in claim 1, wherein each of said threaded rod of said seat-moving unit and said output rod of said speed reduction unit is formed with a gear sleeved fixedly thereon, said wheelchair further comprising a driving belt that has a toothed inner surface and that is trained on said gears of said threaded rod and said output rod so as to transfer the rotation of said output rod to said threaded rod.
